(19) United States
(12) Patent Application Publication
(10) Pub. No.: US 2010/0096377 A1
(43) Pub. Date: Apr. 22, 2010

(54) VEHICLE DE-ICING APPARATUS

(76) Inventor: Shawn Walter ZUBRECKI, Maple Ridge (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/254,911

(22) Filed: Oct. 21, 2008

(51) Int. Cl. B60L 1/02

(52) U.S. Cl. 219/202

(57) ABSTRACT

Apparatus is provided for de-icing the door lock, wiper blades and door molding of a vehicle. The apparatus includes a lock heater, a wiper blade heater and a door molding heater, connectable to a power supply through thermostat switches and control switches. The apparatus also includes a controller for controlling supply of power to each of the lock heater, wiper blade heater and door molding heater. The controller closes or opens the control switches in response to commands received from a user input. The user input may comprise a remote control. The controller may also close or open the control switches based on the state of a timer, reset button and vehicle ignition system.

### TECHNICAL FIELD

This invention relates to apparatus for installation in vehicles to de-ice or defrost components of vehicles which are subject to icing in cold climates. Particular embodiments of the invention are directed to apparatus for de-icing or defrosting a door lock, door molding and a windshield wiper blade of a vehicle.

### BACKGROUND

In cold climate regions, ice may form on a vehicle while the vehicle is parked outside or in an unheated building. The ice may have formed as a result of condensation or precipitation collecting and freezing on the vehicle exterior. In particular, ice may form on or around the vehicle lock. This creates difficulties with unlocking the vehicle door, as the ice can block insertion of a key into the lock or impede rotation of the lock cylinder. Ice may also form around the vehicle door, so as to wedge the door in the door frame and prevent the door from being opened.

Ice may further form on the vehicle windshield wipers while the vehicle is parked or moving. For example, the ice may build up on the linkages which connect the wiper blade to the rods and gears driving the wiper blade. The ice build up impedes windshield wiper operation which can be particularly dangerous in winter driving conditions.

The prior art has evolved various solutions for thawing vehicle door locks. However, these solutions may incorporate de-icing devices which are external to the vehicle, and/or which may be inconvenient to carry and difficult to use. Further, in using such prior art devices, the operator may be required to stand outside the vehicle while thawing the door lock. Also, once the operator has thawed the door lock and is able to unlock the vehicle, the operator may be faced with the further challenge of prying open the vehicle door which may be stuck in the door frame due to ice around the door and on the door molding. The operator may also be faced with the problem of ice build up on the windshield wipers.

There is a desire for apparatus for de-icing and/or defrosting components of vehicles which address or at least ameliorate the deficiencies with the prior art.

### BRIEF DESCRIPTION OF DRAWINGS

In drawings which illustrate non-limiting embodiments of the invention,

FIG. 1 schematically depicts the components of a vehicle defrosting apparatus according to a particular embodiment of the invention;

FIG. 2 is a perspective view of a vehicle lock heater according to a particular embodiment of the invention that may be used in the apparatus of FIG. 1;

FIG. 3 is a perspective view of the FIG. 2 vehicle lock heater with its housing and plaster partially cut away to reveal the heating wire of the vehicle lock heater;

FIG. 4 is a side elevation view of a vehicle wiper blade heater assembly according to a particular embodiment of the invention that may be used in the apparatus of FIG. 1;

FIG. 4A is a sectional view taken along line B-B of FIG. 4;

FIG. 5 is a side elevation view of a door having a door molding heater according to a particular embodiment of the invention that may be used in the apparatus of FIG. 1;

FIG. 5A is a sectional view taken along line A-A of FIG. 5; and

FIG. 6 is a top elevation view of a display and user input module according to a particular embodiment of the invention that may be used in the apparatus of FIG. 1.

### DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

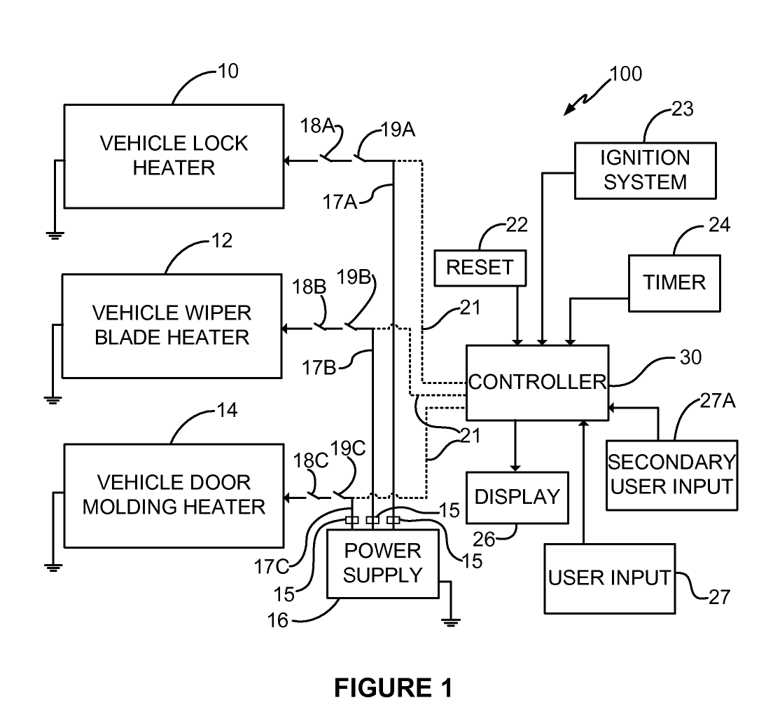

FIG. 1 shows a schematic block diagram of a vehicle de-icing apparatus 100 according to one embodiment of the invention. In the illustrated embodiment, apparatus 100 comprises a vehicle lock heater 10, a vehicle wiper blade heater 12 and a vehicle door molding heater 14. Heaters 10, 12 and 14 receive power from a power supply 16 to respectively thaw the vehicle lock, wiper blade assembly and door molding, as will be described in more detail below. Power supply 16 may be a vehicle battery or other source of power in the vehicle. Power supply leads 17A, 17B, 17C (collectively, power supply leads 17) electrically connect power supply 16 to heaters 10, 12 and 14 respectively.

The output of power supply 16 to heaters 10, 12 and 14 may be respectively controlled by thermostat switches 18A, 18B and 18C (collectively, thermostat switches 18). Thermostat switches 18 are placed in a closed position to permit current flow to respective heaters 10, 12 and 14 only if the temperature is below a threshold temperature (e.g. −1° Celsius/30.2° Fahrenheit or below). Thermostat switches 18 thereby ensure that heaters 10, 12 and 14 receive current and emit heat only in certain temperature conditions (e.g. when the temperature is such that there is a possibility of icing on the vehicle lock, wiper blade assembly and door molding). Thermostat switches 18 may prevent heaters 10, 12 and 14 from being unnecessarily activated, for example, by the user pressing a command button on user input 27 to activate the heaters when the temperature is above freezing. If heaters 10, 12 and 14 are activated, thermostat switches 18 are placed in the open position to deactivate heaters 10, 12 and 14 if the temperature increases to the threshold temperature or higher. Thermostat switches 18 may be encased in a protective housing.

In particular embodiments, thermostat switches 18 are located proximate to components which are heated by heaters 10, 12 and 14. The temperatures at the different thermostat switch locations may be different from one another and from the exterior temperature (i.e. the temperature outside of the vehicle). However, each thermostat switch 18 operates, between open and closed positions, in response to the temperature at the location of thermostat switch 18. For example, thermostat switch 18A may be positioned in door 28 at a location near lock 29 (e.g. at a location about 38 mm (1.5 inches) away from cylinder 34 of lock 29). If the exterior temperature has warmed up to above −1° Celsius (30.2° Fahrenheit) but the area at which thermostat switch 18A is located is below −1° Celsius (30.2° Fahrenheit), thermostat switch 18A will permit current flow to heater 10 upon activation of heater 10. Similarly, thermostat switch 18B may be positioned near wiper blade assembly 49 (e.g. about 38 mm (1.5 inches) away from wiper blade 46) to operate in response to a temperature near wiper blade assembly 49. Thermostat switch 18C may be positioned in door 28 at a location near door molding 54 (e.g about 38 mm (1.5 inches) away from door molding 54) to operate in response to a temperature near door molding 54.

In other embodiments, the control circuit may be configured to allow the operator to manually override thermostat switches 18. For example, an override circuit incorporating a resistor and switch may be connected in parallel to each of the thermostat switches 18. When the operator wishes to override thermostat switches 18, the operator causes controller 30 to send a control signal to place the switch of each override circuit in a closed position to permit current flow to respective heaters 10, 12 and 14 (by way of the override circuit) even if the thermostat switches 18 are in the open position. Other suitable mechanisms for overriding thermostat switches 18 may be provided in other embodiments.

The output of power supply 16 to heaters 10, 12 and 14 may further be controlled by switches 19A, 19B and 19C respectively (collectively, switches 19). In the illustrated embodiment, controller 30 transmits signals 21 to switches 19 for selectively closing or opening such switches to activate or deactivate a supply of power to each of heaters 10, 12 and 14. Controller 30 may be a suitable controller such as a microprocessor, computer, ASIC, PLA or the like. The signals transmitted by controller 30 to switches 19 may be determined by command signals received from a user input 27 and, optionally, from a secondary user input 27A.

Controller 30 may also transmit signals 21 to switches 19 based on the state of reset button 22, timer 24, and/or ignition system 23. Controller 30 may also output, to a display 26, certain information such as whether heaters 10, 12 and 14 have been activated or deactivated, or whether there is a potential problem with the operation of one of heaters 10, 12 and 14. Switches 19, controller 30 (including the wiring of controller 30), reset button 22, timer 24, secondary user input 27A and/or display 26 may be implemented by hardware and/or software which is housed in one or more modules for installation in a vehicle. Each module may be installed in a vehicle during vehicle manufacture or the module may be retrofitted into an existing vehicle.

User input 27 may comprise a combination of one or more devices which allow an operator to transmit commands to controller 30. In some embodiments, user input 27 is advantageously a remote control to permit operation of apparatus 100 while the operator is in a location remote to the vehicle (for example, while the operator is inside a building which is adjacent to the street or parking lot where the vehicle is parked). In some embodiments, user input 27 has push-buttons or switches which allow the operator to send one or more of the following commands to controller 30:
selection of one or more of vehicle lock heater 10, vehicle wiper blade heater 12, and vehicle door molding heater 14 which the user desires to activate.
ON/OFF. In some embodiments, selecting ON will simultaneously activate only those heaters selected by the operator, and selecting OFF will simultaneously deactivate all heaters. In other embodiments, there may be specific ON and OFF inputs for each of the heaters. In still other embodiments, selecting ON will by default activate all of the heaters. In still other embodiments, selecting ON will activate both of the vehicle lock heater 10 and vehicle door molding heater 14.
heat level settings (e.g. HIGH or LOW) or temperature settings.
   If user input 27 is a battery-powered remote control, user input 27 may have an LED light which flashes when an input has been activated, indicating to the operator that the battery of the remote control is functioning. When the battery becomes weak, the LED may flash slower and/or less brightly, indicating to the operator that the battery needs changing.

When the operator sends a command (e.g. by user input 27) to activate one or more of heaters 10, 12 and 14, controller 30 outputs a signal 21 to close appropriate switches 19 so as to activate the selected heater(s).

In some embodiments, selecting the ON state with user input 27 activates both vehicle lock heater 10 and vehicle door molding heater 14. Upon receiving the ON or activation signal from the operator, controller 30 outputs a signal 21 to close switches 19A and 19C. Controller 30 also starts timer 24 to record an elapsed time. Once a predetermined time has elapsed (e.g. 5 minutes) according to timer 24, controller 30 outputs a signal 21 to open switches 19A and 19C thereby deactivating heaters 10 and 14. Use of timer 24 ensures that heaters 10 and 14 are not inadvertently left on for prolonged periods of time. If the operator wishes to continue with heating, the operator must reactivate heaters 10 and 14 through user input 27. The predetermined time that a heater may be left on before it is deactivated may be configurable by the operator.

While only one timer 24 is shown in FIG. 1, in some embodiments, there may be separate timers associated with heaters 10, 12 and/or 14, so that the duration for which each heater is ON may be independently controlled. Controller 30 may send a deactivation signal to the appropriate switch 19 when the predetermined time has elapsed.

In the illustrated embodiment of FIG. 1, individual circuit breakers 15 (e.g. 15A or 20A circuit breakers) may be connected to protect heaters 10, 12 and 14 in the event of an overload or other fault condition. Circuit breakers 15 may be reset by the operator.

In some embodiments, display 26 may provide an indicator indicating faulty or abnormal operation of heaters 10, 12 and 14. For example, circuitry may detect whether any of circuit breakers 15 has been triggered, and display 26 may display a message or turn on a light on the display indicating that one or more of heaters 10, 12 and 14 has been deactivated due to a potential problem. FIG. 6 depicts one example display and user input module 41 incorporating a display 26 and a secondary user input 27A. Each of the light indicators 25A, 25B and 25C (which form part of the display 26) may be associated with a circuit breaker 15 for one of heaters 10, 12 and 14, and is turned on when the associated circuit breaker 15 has been triggered.

In some embodiments, controller 30 may accept a reset command from reset input 22 depressed by the operator, causing controller 30 to send a signal to open all of switches 19 to deactivate heaters 10, 12 and 14. Reset input 22 may be incorporated in user input 27 (e.g. the remote control), and/or may be incorporated in another user control interface connected to controller 30 such as secondary user input 27A on display and user input module 41 (FIG. 6).

Vehicle wiper blade heater 12 may be controlled differently from vehicle lock heater 10 and vehicle door molding heater 14 in some embodiments. For example, secondary user input 27A may have an ON/OFF button or switch 32 for activating/deactivating vehicle wiper blade heater 12. In some embodiments, activation of heater 12 is triggered by the vehicle ignition in addition to, or instead of, commands from the operator. For example, controller 30 may be connected to vehicle ignition system 23 to detect whether the vehicle is running (i.e. ignition is ON) or not running (i.e. ignition is OFF). If controller 30 determines that the vehicle is running, controller 30 sends a signal to close switch 19B to permit current flow to heater 12. As soon as controller 30 has detected that the vehicle has ceased running, controller 30 sends a signal to open switch 19B. The heat level (e.g. HIGH/LOW or temperature setting) of heater 12 may be adjustable. In the illustrated embodiment, the heat level of heater 12 may be controlled by selecting one of the HIGH and LOW inputs 13A, 13B on secondary user input 27A (FIG. 6). The default heat level setting of heater 12 may be set to LOW.

In other embodiments, the activation/deactivation and heat level of heater 12 may be controlled by a multi-function push button. Pushing the button a first time turns heater 12 ON and sets the heat level of heater 12 to LOW. Pushing the button a second time sets the heat level of heater 12 to HIGH. Pushing the button a third time turns heater 12 OFF.

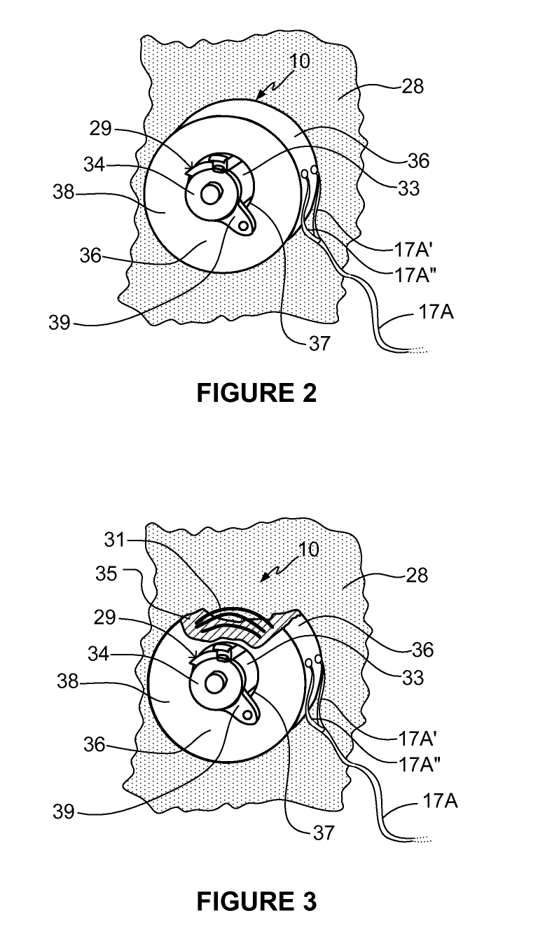

During normal operation in non-freezing temperature conditions, when a key is inserted into a lock 29 and rotated about the lock's axis, cylinder 34 of lock 29 is caused to rotate about its axis within a cylindrical lock shaft 33 that is secured to vehicle door 28 (FIGS. 2 and 3). This action unlocks door 28. However, when ice has formed on or in lock 29, the ice may block the key from being inserted in lock 29, or the ice may prevent rotation of cylinder 34 within shaft 33. In such circumstances, the ice must be thawed or broken before cylinder 34 can be rotated to unlock door 29. In the illustrated embodiment, vehicle lock heater 10 comprises an annular piece that is installed around cylinder 34 of lock 29 to heat and thaw out ice which has formed on lock 29.

As best seen in FIG. 3, heater 10 incorporates a resistance heating wire 31, embedded in an electrically-insulating plaster material 35. Plaster material 35 is encased in a housing 36 which may be made of copper. To construct heater 10, heating wire 31 is coiled and placed in a partially constructed housing 36 (which is left open on one side, for example, through face 38, allowing for insertion of heating wire 31). Opposite ends of heating wire 31 are arranged to protrude from apertures in housing 36. A heat-resistant plaster 35 in liquid form is poured into housing 36 and around heating wire 31, and cured. Next, face 38 of housing 36 is soldered on or otherwise attached to the remainder of housing 36 to seal plaster 35 and heating wire 31 inside housing 36 to form vehicle lock heater 10. Housing 36 has a bore 37 shaped to accommodate cylinder 34 of lock 29. Vehicle lock heater 10 is installed by sliding cylinder 34 through bore 37. At least a portion of the surfaces of housing 36 defining bore 37 and adjacent to cylinder 34 may contact surfaces of cylinder 34 and/or may be positioned slightly apart from surfaces of cylinder 34 (e.g. by a maximum separation of 7 mm/0.2756 inch). Heater 10 may then be secured to cylinder 34 by a spring clip 39 or other suitable retaining device which prevents heater 10 from detaching from or sliding off cylinder 34 but which still permits rotation of cylinder 34 within lock shaft 33.

Heating wire 31 is electrically connected to power supply 16. In particular embodiments, power supply 16 is a DC vehicle battery (e.g. 12 to 24 Volt battery) and opposite ends of heating wire 31 are electrically connected to a pair of power supply leads 17A′, 17A″ respectively (collectively, power supply leads 17A) one of which may be connected to a positive terminal of power supply 16 via switches 18, 19 and circuit breakers 15 and the other one of which may be connected to a negative terminal of power supply 16. When power is supplied to vehicle lock heater 10 through power supply leads 17A, wire 31 heats up through resistive heating of heating wire 31. Heat from heating wire 31 is conducted through plaster 35 and housing 36, and heats cylinder 34 and other components of lock 29 to thaw ice which has formed on lock 29.

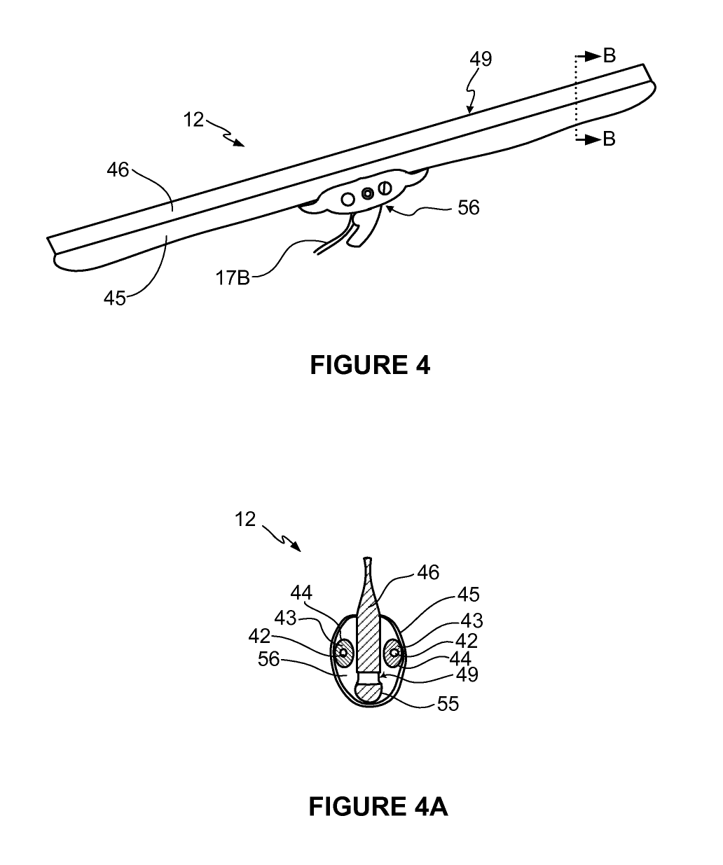

In the illustrated embodiment of FIG. 4, vehicle wiper blade heater 12 is installed in vehicle wiper assembly 49. Vehicle wiper assembly 49 may be a conventional vehicle wiper assembly having a wiper blade 46 mounted to a base 55 (FIG. 4A). Base 55 is connected to arms, rods or other linkages 56 for driving vehicle wiper assembly 49. Vehicle wiper blade heater 12 incorporates a semi-rigid or flexible protective casing 45 which is shaped to fit around at least a portion of vehicle wiper assembly 49, such as, for example, the portion of vehicle wiper assembly 49 below blade 46. Casing 45 may be a rubber, snugly-fitting casing, for example, which is stretched and placed around vehicle wiper assembly 49. Spring-loaded clips or other suitable fasteners may be used for removably securing casing 45 to vehicle wiper assembly 49. Vehicle wiper blade heater 12 also incorporates one or more electrically-insulated heating strips 44 enclosed in casing 45. A heating strip 44 may extend along a length of vehicle wiper assembly 49 on either side of vehicle wiper assembly 49 (FIG. 4A). Heating strips 44 comprise a resistance heating wire 42 housed in tubing 43 made of an electrically-insulating material (e.g. flexible nylon, rubber, vinyl). Heating wire 42 is connected to power supply 16 via power supply lead 17B, switches 18B, 19B and circuit breaker 15. The portion of power supply lead 17B extending from heating wire 42 may be secured to an arm of linkages 56 so as not to interfere with the operation of vehicle wiper assembly 49.

When power is supplied to heating wire 42, heating wire 42 heats up through resistive heating. Heat from heating wire 42 is conducted through tubing 43 to heat an air space 56 between heating strip 44 and casing 45, and to heat casing 45 and vehicle wiper assembly 49. The heat thaws ice which has built up on vehicle wiper assembly 49. When not in use, the components of vehicle wiper blade heater 12 (e.g. casing 45 and all of the heating components therein) may be detached from vehicle wiper assembly 49 and stored.

In some embodiments, vehicle wiper assembly 49 is provided with a built-in, non-detachable vehicle wiper blade heater 12 having the components described above. Vehicle wiper assembly 49 may replace a conventional vehicle wiper assembly during winter months. Vehicle wiper assembly 49 may have a replaceable rubber wiper blade 46.

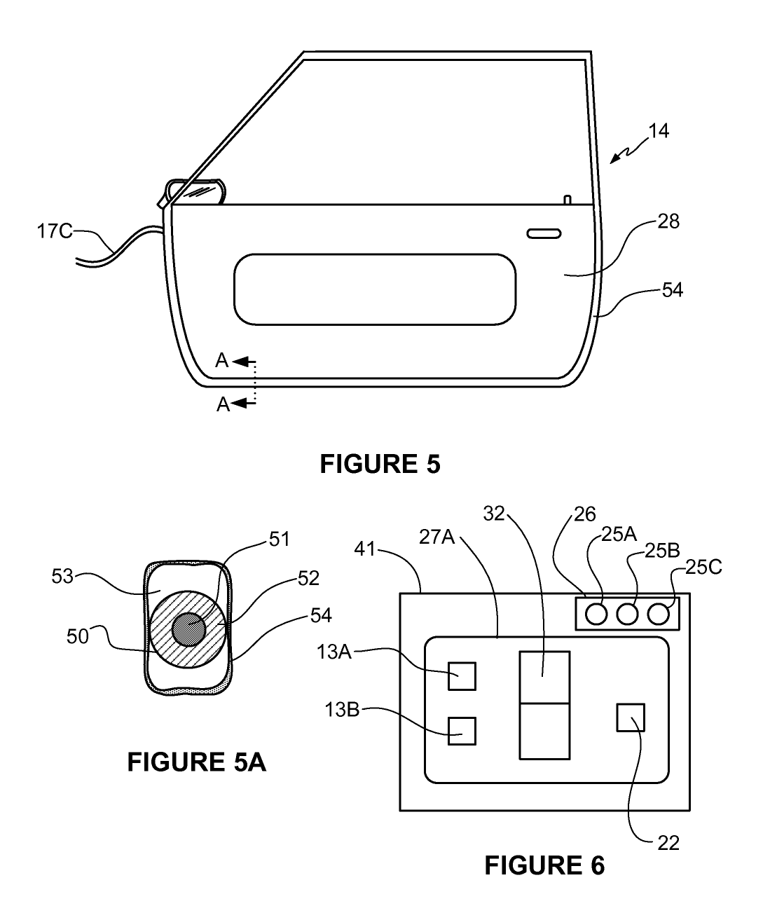

In the illustrated embodiment of FIG. 5, door molding heater 14 comprises an electrically-insulated heating strip 50 comprising a resistance heating wire 51 housed in tubing 52 made of an electrically-insulating material (e.g. flexible nylon, rubber, vinyl). The heating strip 50 is inserted inside molding 54 of door 28 (FIG. 5A). In the illustrated embodiment, door molding 54 is shown as a hollow tube and heating strip 50 is positioned in the space within the hollow tube. Door molding 54 may be a rounded hollow tube. However, this is not necessary. Door molding 54 may comprise a strip having an L-shaped cross-section or a U-shaped cross-section, for example, defining a concavity in which heating strip 50 may be received.

Heating wire 51 is connected to power supply 16 via power supply lead 17C, switches 18C, 19C and circuit breaker 15. When power is supplied to heating wire 51 from power supply 16, heating wire 51 heats up through resistive heating. Heat from heating wire 51 is conducted through tubing 52 to heat a space 53 between heating strip 50 and molding 54, and also to heat molding 54 to thaw ice which has formed on molding 54.

The embodiments of apparatus 100 described herein may be installed in a vehicle during manufacture of the vehicle, or may be provided as kits for retrofit installation in a vehicle.

To install vehicle lock heater 10, the inside panel cover of door 28 is removed/absent to expose lock 29. Vehicle lock heater 10 is placed around cylinder 34 of lock 29, and secured in place by spring clip 39 or another retaining device. Power supply lead 17A connected to heating wire 31 may be strapped to door 28, and routed past the hinges of door 28 (along with other wiring for electrically-powered components installed in door 28, such as power door locks, power door windows, etc.) Power supply lead 17A may be wired through controller 30 to power supply 16.

To install vehicle door molding heater 14, heating strip 50 is inserted in door molding 54. In some embodiments, this step is not required as door molding 54 may be provided with heating strip 50 embedded in door molding 54. Heating strip 50 and/or door molding 54 may be cut to have a length to extend around the perimeter of door 28. Door molding 54 is fitted around the periphery of door 28. Door molding 54 may be attached to door 28 using clips, adhesive or any other suitable attachment means known to those of skill in the art. Power supply lead 17C connected to heating wire 51 may be routed past the hinges of door 28 (along with other wiring for electrically-powered components installed in door 28), and wired through controller 30 to power supply 16. In some embodiments, door molding heater 14 may be installed only around the driver door 28. In other embodiments, door molding heater 14 may be installed around both the driver door 28 and one or more of the passenger doors 28.

To install vehicle wiper blade heater 12, casing 45 and the heating components contained therein may be fitted around vehicle wiper assembly 49 on the vehicle. In other embodiments where vehicle wiper assembly 49 is provided with a built-in vehicle wiper blade heater 12, the existing wiper blade assembly on the vehicle is removed and the vehicle wiper assembly 49 with heater 12 is installed on the vehicle. Power supply lead 17B is routed past arms or linkages 56 connected to vehicle wiper assembly 49, and wired through controller 30 to power supply 16.

Controller 30 may be mounted inside the vehicle (e.g. under the vehicle dash). Display and user input module 41 is wired to controller 30 and may also be mounted inside the vehicle (e.g. under the vehicle dash).

The embodiments of apparatus 100 described herein may be adapted for use in defrosting door locks, door moldings and windshield wipers of different kinds of vehicles, including cars, trucks, vans, buses, trains, aircraft, industrial mining vehicles, forestry vehicles, loaders, boats, ships, and the like.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An apparatus for de-icing a lock, a wiper blade assembly and door molding of a vehicle, comprising:
a lock heater attachable to the lock and electrically connectable to a power supply through a first control switch;
a wiper blade heater attachable to the wiper blade assembly and electrically connectable to the power supply through a second control switch;
a door molding heater insertable in the door molding and electrically connectable to the power supply through a third control switch; and,
a controller for controlling a supply of power from the power supply to the lock heater, wiper blade heater and the door molding heater, wherein the controller is configured to open or close the first, second and third control switches in response to an input signal received from a user input.

2. The apparatus according to claim 1, wherein the controller is configured to close the first and third control switches and to activate a timer upon receiving a user input activation signal from the user input, and to open the first and third control switches when a predetermined time period has lapsed according to the timer.

3. The apparatus according to claim 1, wherein the lock heater comprises a housing having a bore therethrough for receiving a cylinder of the lock.

4. The apparatus according to claim 3, wherein the lock heater comprises a resistance heating wire embedded in plaster and encased in the housing, the resistance heating wire electrically connectable to the power supply through the first control switch.

5. The apparatus according to claim 1, wherein the wiper blade heater comprises an electrically-insulated heating strip.

6. The apparatus according to claim 5, wherein the wiper blade heater comprises a casing enclosing the electrically-insulated heating strip, the casing shaped to fit around at least a portion of the wiper blade assembly.

7. The apparatus according to claim 6, wherein the wiper blade heater is removably attachable to the wiper blade assembly.

8. The apparatus according to claim 6, wherein the electrically-insulated heating strip comprises a resistance heating wire encased in electrically-insulating tubing, the resistance heating wire electrically connectable to the power supply through the second control switch.

9. The apparatus according to claim 1, wherein the door molding heater comprises an electrically-insulated heating strip insertable in the door molding.

10. The apparatus according to claim 9, wherein the electrically-insulated heating strip comprises a resistance heating wire encased in electrically-insulating tubing, the resistance heating wire electrically connectable to the power supply through the third control switch.

11. The apparatus according to claim 1, wherein the lock heater is electrically connectable to the power supply through a first thermostat switch.

12. The apparatus according to claim 11, wherein the wiper blade heater is electrically connectable to the power supply through a second thermostat switch.

13. The apparatus according to claim 12, wherein the door molding heater is electrically connectable to the power supply through a third thermostat switch.

14. The apparatus according to claim 13, wherein for each of the first, second and third thermostat switches, the thermostat switch is configured to be in a closed position if a temperature at a location of the thermostat switch is less than 1 degree Celsius.

15. The apparatus according to claim 14, wherein the first thermostat switch is located about 1.5 inches away from the lock heater.

16. The apparatus according to claim 15, wherein the second thermostat switch is located about 1.5 inches away from the wiper blade assembly.

17. The apparatus according to claim 16, wherein the third thermostat switch is located about 1.5 inches away from the door molding.

18. The apparatus according to claim 1, comprising a circuit breaker connected between the power supply and each of the lock heater, wiper blade heater and door molding heater.

19. The apparatus according to claim 1, wherein the controller is connected to a vehicle ignition system such that the controller detects running of a vehicle ignition, and the controller is configured to close the second control switch if the vehicle ignition is running and to open the second control switch if the vehicle ignition is not running.

20. The apparatus according to claim 1, comprising a display connectable to the controller for displaying an indication of an operational status of each of the lock heater, wiper blade heater and door molding heater.

21. An apparatus for de-icing components of a vehicle, comprising:
a heater comprising at least one of:
a lock heater attachable to a vehicle lock;
a wiper blade heater attachable to a vehicle wiper blade; and
a door molding heater insertable in a vehicle door molding;
wherein the heater is electrically connectable to a vehicle power supply through a control switch; and
a controller for controlling a supply of power from the vehicle power supply to the heater, the controller configured to open or close the control switch in response to an input signal received from a user input.

22. A vehicle comprising the apparatus according to claim 1.

23. A vehicle de-icing kit comprising:
a lock heater attachable to a lock of the vehicle;
a vehicle wiper assembly comprising a wiper blade heater;
a door molding strip comprising a door molding heater;
a controller for controlling a supply of power from a vehicle power supply to:
the lock heater through a first control switch;
the wiper blade heater through a second control switch; and
the door molding heater through a third control switch;
wherein the controller is configured to open or close the first, second and third control switches in response to an input signal received from a user input; and
means for electrically connecting the lock heater, wiper blade heater and door molding heater to the vehicle power supply through the first, second and third control switches, respectively.
